(19) United States
(12) Patent Application Publication
(10) Pub. No.: US 2011/0314384 A1
(43) Pub. Date: Dec. 22, 2011

(54) METHOD FOR HANDLING EMAIL MESSAGES AND ATTACHMENTS IN A MOBILE COMMUNICATION SYSTEM

(75) Inventors: Peter Lindgren, Linkoping (SE); Henrik Pettersson, Linkoping (SE); Mattias Wingstedt, Linkoping (SE)

(73) Assignee: VISIARC AB, Stockholm (SE)

(21) Appl. No.: 13/201,140

(22) PCT Filed: Feb. 13, 2009
(86) PCT No.: PCT/SE2009/000087

§ 371 Date: Aug. 11, 2011

(51) Int. Cl. G06F 3/01; G06F 15/16

(52) U.S. Cl. 715/739

(57) ABSTRACT

An email handling system having a mobile terminal with a processor, a user interface and an email database for storing email messages with attachments. The processor is arranged for fetching from the email database and displaying on the user interface, a list of email messages of an email account, responsive to an input command from a user to add an attachment to an outgoing email message. The processor fetches from the email database and displays on the user interface a list of attachments of a selected first email message out of the list of email messages, responsive to an input command from a user selecting the first email message. The system adds to the outgoing email message a selected first attachment out of the list of attachments from an existing email message responsive to a user input command.

### TECHNICAL FIELD

The present disclosure relates to methods, systems and mobile terminals for handling email messages. More specifically, the disclosure relates to methods, systems and mobile terminals for handling email messages and attachments in a mobile communication terminal.

### BACKGROUND

Last couple of decades, electronic mail (email) has become a mission critical means of communication. As well, to communicate via email from your mobile terminal, such as your mobile phone, has become increasingly popular, and email volumes are growing every day. At the same time never have so many electronic documents (documents) been created before. Attaching one or multiple documents to email messages has become one of the most common ways of sharing documents. With the increasing volume of email messages and the sheer size and number of attached documents, email inboxes are becoming larger. Managing email messages that more frequently have documents attached, which documents have become larger in average, has become increasingly cumbersome on a mobile terminal, because of the limited resources on the mobile terminal, i.e. a small display, limited communication resources (e.g. limited bandwidth over the air interface), limited memory resources etc.

A common use case for composing email messages is to attach documents to outgoing email message, documents that have been received as an attachment of a received email message or that has been sent as an attachment in a previously sent email message (saved emails). Often it is only the specific attachment that is of interest, not the text of the saved email message. To add documents to an outgoing email message, documents that have been received as an attachment in an earlier email message is a very simple task on a desktop or laptop computer, which the user completes without reflection: Just save the attachment, drag it from the file system and drop it on the email composer window, or use copy and paste. However on a mobile terminal the task is not that easy. It takes time to download a document and it is harder to use the file system. Also, some terminals do not even have a user accessible file system. Further, it is not possible to use drag-and-drop since only one application window is visible at a time. Therefore, there is a need for a system and method for improving the handling of email messages on a mobile communication device.

US2008/0201668 shows an email communication system providing an email folder hierarchy for user navigation of received email messages on the display of a mobile device and a separate electronic file attachment folder hierarchy for user navigation of the electronic file attachments that were comprised in the received email messages. Also, a new hierarchical level is created, where the file attachments are sorted based on different properties (e.g. based on sender, subject or date). The purpose of this system is to improve the handling of email messages with attachments on a mobile communication device.

In this system, when a user is to add an attachment received in an earlier email message to a new email message, a separate attachment folder hierarchy will be displayed for the user, which folder is arranged differently to the user's normal email folder hierarchy (e.g. inbox etc.). The user then has to know and search for either the name of the sender of the email message or the header of the email message to find the interesting attachment. It will be confusing to the user to be confronted with a new folder hierarchy than the usual email folder hierarchy. This may be rather cumbersome for the user since often a user rather remembers in which email message an attachment was received than certain separate parameters like the header of the email message. Also, in this system the documents and files have to be downloaded to the device from the email database, which requires lots of bandwidth for the transmission and takes lots of storage space of the device. Further, the list of attachments may be very long since each attachment is represented per row.

Consequently, there is a need of a method that makes it easier to handle email messages with attachments on a mobile terminal.

### SUMMARY

It is an object of the present invention to provide a method that would facilitate the handling of email messages in a mobile terminal. Furthermore, it is an object of the present invention to provide a method for facilitating the handling of email attachments on a mobile terminal. Another object of the invention is to improve a user's experience of handling email attachments on his/her mobile terminal. Yet another object of the invention is to facilitate browsing through email accounts on a mobile terminal. Still another object of the invention is to facilitate the process of adding an attachment to an outgoing email message in a mobile terminal. Yet another object is to achieve a mobile terminal that is user friendly in terms of being responsive. Another object is to achieve a mobile terminal with which an attachment could be added to an email message using few input operations from a user.

According to a first aspect of the invention, a method for handling email messages in a mobile communication system is provided, comprising a mobile terminal and an email database. The method comprises: displaying, in a user interface of the mobile terminal, a list of email messages of an email account, responsive to an input command from a user to add an attachment to an outgoing email message; displaying, in the user interface of the mobile terminal, a list of attachments of a selected first email message out of the list of email messages, responsive to an input command from a user selecting the first email message; adding to the outgoing email message, a selected first attachment out of the list of attachments, responsive to an input command from a user selecting the first attachment.

The invention makes it easy to compose email messages with attachments in a mobile terminal. It makes it possible to cherry-pick certain attachments from existing email messages. By confronting the user with a similar appearance on the display as in his mailbox, when he is to add an attachment from a received or sent email message to an outgoing email message, the user will easily find the attachment he is interested in. By displaying a folder hierarchy as described in claim 1, similar to the email hierarchy as used for received email messages, it will be easier for the user to navigate and find an attachment compared to the system of US2008/0201668. Further, this hierarchy is known to the user and thereby more easy to use compared to the system of US2008/0201668.

In this disclosure, an email database is defined as a user specific database for handling and storing email messages received from the external email server through any email exchange protocol. The email database is preferably arranged in the network but it may also be arranged in the mobile terminal. An external email server, on the other hand, is the email server, such as IMAP, POP, SMTP, Gmail etc. receiving email message from the sender of the email message, destined to the receiver.

According to an embodiment of the invention, the method further comprises: storing each processed email message and each attachment attached to each processed email message separately, such that an attachment is stored separated from the email message with which it was attached, and allocating separate identification marks to each processed email message and to each attachment attached to each processed email message. The step of displaying a list of email messages further comprises displaying the list of email messages based on the identification marks of each email message, wherein the step of displaying attachments of a selected email message comprises displaying the attachments based on the identification mark of the email message and the identification mark of each attachment of the selected email message. The step of adding the selected attachment further comprises adding the selected attachment based on its identification mark. By storing the email messages and attachments separately it is possible to select a certain attachment from the email message in which it was received and add the selected attachment to an outgoing email message without having to attach the whole email message. I.e. the attachment could be picked from the email message with which it was received. At the same time, by using identification marks, the attachments of an email message could be found via its email message directly and it will not be necessary to display a separate structure for the attachments, as in prior art systems. By a processed email message is meant an email message that is received from another user or that has been sent from the terminal to another user.

According to another embodiment, the processed email messages and the attachments of the processed email messages are stored in a node hierarchy based on the identification marks, such that each attachment has a reference to its processed email message. Thereby, an attachment is connected to the email message with which it originally belonged. Thereby, the user interface can display a browsable node hierarchy for the user to find the email message and its attachments even though they are stored separately.

According to another embodiment, the attachments and email messages are stored on the email database, and the email database and the mobile terminal are connected via an air interface connection. The steps of displaying a list of email messages and displaying a list of attachments to a selected email message in a user interface of the mobile terminal further comprises transmitting to the mobile terminal from the email database the identification marks of the processed email messages and of the attachments, in response to an input command from a user. By arranging the email database in a node of a communication system, where the email messages and the attachments are stored, and by transmitting the identification marks to the mobile terminal and at least primary not transmitting the whole email messages or attachments, air interface bandwidth and memory capacity in the mobile terminal is saved. Thereby, the process of composing and sending email messages with attachments is fast. The user will even experience the fetching and displaying of information in this process as an instant response. Also, in case of theft of mobile terminal, the user will not lose its saved documents, since they are stored on the central email database.

According to another embodiment, the method further comprises the steps of, responsive to an input command from a user to view at least a part of a selected attachment: producing, in the email database, a visual representation of a part of the selected attachment, and displaying, in the user interface, the visual representation of the part of the selected attachment.

Often a user wants to know the content of the attachment, e.g. to see that it is the right attachment that has been attached to the email message to be sent. By displaying a visual representation of the attachment, a user may see at least parts of the documents and thereby identify if it is the right document. At the same time, a visual representation is more manageable on a screen of a mobile terminal than the actual document. Also, if the actual document is stored at the email database and only a visual representation is sent to the mobile terminal, memory resources at the mobile terminal and bandwidth on the communication channel between the mobile terminal and the email database are saved.

According to a second aspect of the invention, a computer program product is provided, the computer program product being arranged for performing the method of the invention.

According to a third aspect of the invention, an email handling system is provided comprising a mobile terminal having a processor and a user interface for displaying information to the user and for receiving user input commands, and an email database for storing email messages and attachments. The processor is arranged for fetching from the email database and displaying on the user interface, a list of email messages of an email account, responsive to an input command from a user to add an attachment to an outgoing email message. The processor is further arranged for fetching from the email database and displaying on the user interface, a list of attachments of a selected first email message out of the list of email messages, responsive to an input command from a user selecting the first email message. The system is further arranged for adding to the outgoing email message, a selected first attachment out of the list of attachments, responsive to an input command from a user selecting the first attachment.

The invention makes it easy to compose email messages with attachments in a mobile terminal. It makes it possible to cherry-pick certain attachments from existing, processed, email messages. By confronting the user with a similar appearance on the display as in his mailbox, when he is to add an attachment from a processed email message to an outgoing email message, the user will easily find the attachment he is interested in. By displaying a folder hierarchy as described, similar to the email hierarchy as used for received email messages, it will be easier for the user to navigate and find an attachment.

According to an embodiment, the email database is arranged for storing each processed email message and each attachment of each processed email message separately, such that an attachment is stored separated from the email message with which it was attached, and wherein the email database is further arranged for allocating separate identification marks to each email message and to each attachment. The processor is further arranged for fetching the identification marks of each email message of an email account from the email database and displaying the list of email messages on the user interface based on the identification marks of each email message. The processor is further arranged for fetching the identification mark of each attachment of the selected email message from the email database based on the identification mark of the email message and displaying the attachments of the selected email message on the user interface based on the identification mark of the email message and the identification mark of the attachments of the selected email message. The email database is arranged for adding the selected attachment to the outgoing email message by fetching the selected attachment based on its identification mark.

According to an embodiment, the email database is arranged for allocating identification marks to the processed email messages and to the attachments of each processed email message and storing the email messages and attachments, such that each attachment has a reference to its email message with which it was attached, and such that each email message has a reference to each attachment originally attached to the email message. In this way, a node hierarchy based on the identification marks is achieved, which makes it easy to browse through the email structure to find the attachments that the user wants to attach to an email message in composition, even if the attachments are stored separated from their original email messages.

According to another embodiment, the mobile terminal and the email database are arranged to communicate with each other via an air interface connection. Thereby, and since it is not necessary to send the whole email messages and messages over the air interface connection for finding an attachment and attaching the attachment to an outgoing email message, bandwidth of the air interface connection is saved, and also memory capacity of the mobile terminal.

According to another aspect of the invention, a mobile communication terminal arranged for use in an email handling system of the third aspect of the invention is provided.

### BRIEF DESCRIPTION OF THE DRAWINGS

The invention will in the following be described in more detail with reference to the enclosed drawings, wherein:

FIG. 1 is a schematic block diagram of an email handling system according to the invention.

FIG. 2 is a schematic tree structure of an exemplary node hierarchy according to the invention.

FIG. 3 is a schematic representation of a “Compose email”-view shown on a display of a mobile terminal according to the invention.

FIG. 4 is a schematic representation of a “Choose email account”-view shown on a display of a mobile terminal according to the invention.

FIG. 5 is a schematic representation of a “Select email”-view shown on a display of a mobile terminal according to the invention.

FIG. 6 is a schematic representation of an “Add attachment from saved email”-view shown on a display of a mobile terminal according to the invention.

FIG. 7 is a schematic representation of a “Compose email”-view, for an email with three attachments attached, shown on a display of a mobile terminal according to the invention.

FIG. 8 is a schematic tree structure of an example of a node hierarchy according to the invention.

FIG. 9 is a schematic representation of an “Add Document from Document Archive as Attachment”-view shown on a display of a mobile terminal according to the invention.

FIG. 10 is a flow chart describing a method for storing an email message with attachment according to the invention.

FIG. 11 is a flow chart describing a method for handling an email message and an attachment according to the invention.

### DESCRIPTION OF EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

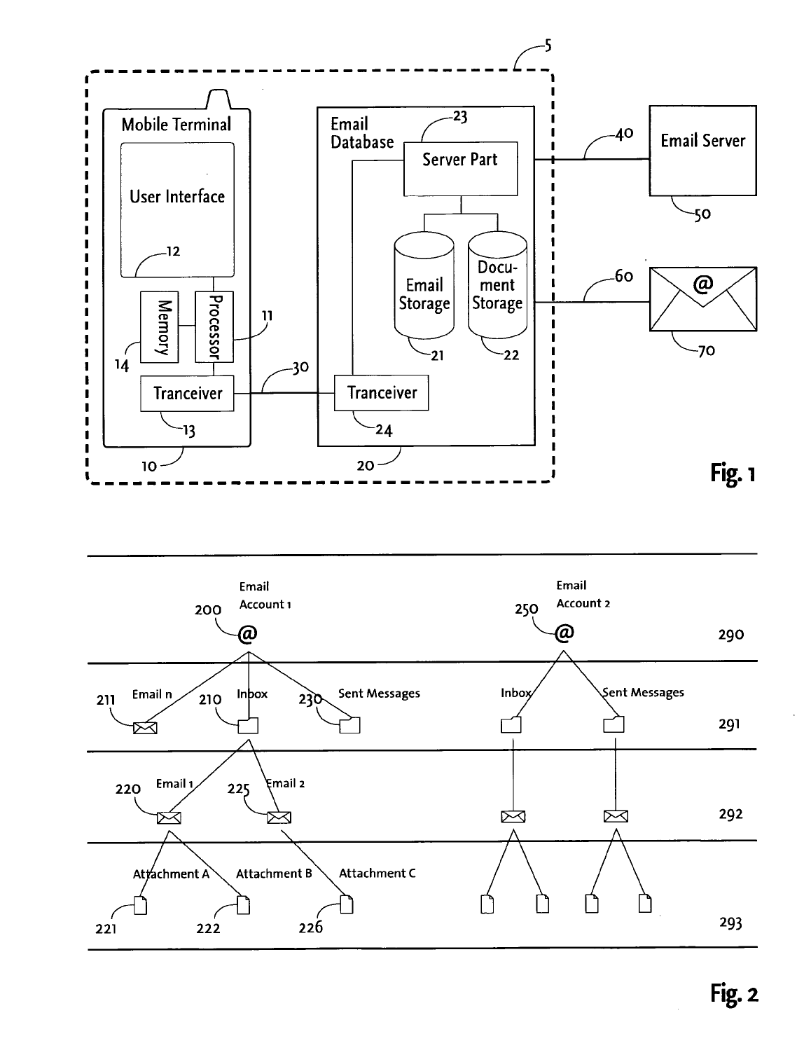

FIG. 1 describes an email handling system 5 according to the invention. The system 5 comprises: a mobile terminal 10 having a processor 11, a user interface 12, a transceiver 13 and a memory 14; and an email database 20 having a server part 23, an email storage 21, a document storage 22 and a transceiver 24. The user interface 12 of the mobile terminal has a display for displaying information to the user and various input devices, such as one or more of a numeric keypad, a keyboard, a joystick, a pen or a touch based display. The processor 11 is arranged to handle communication between different parts of the mobile terminal and to/from the mobile terminal and execution of different commands etc. The email database 20 is arranged to act as a server and is arranged to run on a server computer having Internet connectivity. The mobile terminal 10 and the email database 20 are arranged to communicate with each other via their respective transceivers 13, 24 over a mobile Internet connection 30. The email database 20 is further connected to an external incoming email server 50 via a communication link 40, e.g. an Internet connection, and to an external outgoing email server 70 via another communication link 60. The communication links 40 and 60 may be the same communication link.

The external incoming email server 50 manages incoming email messages, i.e. email messages going in the direction towards the email account of the user of the mobile terminal 10, and access to these incoming email messages. Examples of incoming email servers are IMAP, POP etc. The external outgoing email server 70 manages the sending of email messages from the user's email account. An example of an outgoing email server is SMTP. Other email servers that may be used in connection with the invention manage incoming email messages, accessing the incoming emails and sending emails. Examples of such email servers are Microsoft Exchange, Gmail, Yahoo!, Hotmail etc. All email servers share the characteristic of supporting the MIME standard for email. The MIME standard allows email messages to contain multiple parts. An email message that has one or multiple attachments is a multi-part MIME message, but it is still one data file.

When new incoming email messages are available in the incoming email server 50, these are downloaded from the email server over the communication link 40 through an email exchange protocol to the email database 20 where the email message is stored in the email storage 21. The email storage 21 contains email messages and email attachments that has been fetched from the external incoming email server 50. The document storage 22 of the email database is a document archive that contains documents that may have been received in another way than via email, e.g. a document downloaded from the Internet. From the user interface 12 the user can publish documents e.g. on the Internet from the mobile terminal and interact with the documents in the same way as for email attachments, as will be described in more detail further down in the document. The email database server part 23 is arranged for handling the email messages, attachments and documents stored in the email storage 21 and the document storage 22, e.g. to store the email messages, attachments and documents and to fetch the email messages, attachments and documents from the respective storage on demand.

According to the invention, when an incoming email message comprising one or more attachments is received at the external incoming email server 50 and communicated to the email database 20, the server part 23 separates the attachments from the email message and gives each attachment and also the email message a separate and unique identification mark, such as an identification number. The identification mark given to the email message is different to the identification mark given to the attachments of the email message. That is, if multiple attachments are attached to the incoming email message, each attachment is extracted from the one data file comprising both the actual email message and the attachments, and stored separated from the email message itself. I.e. the email message is stored such that it does not contain its attachments.

According to the invention, a node hierarchy is created in the email storage 21. The node hierarchy is described in FIG. 2, in an example where a user has two email accounts 200, 250. The email account nodes 200, 250 are arranged on a top level 290 of the node hierarchy. The first email account 200 has a number of child nodes which are folders, in the figure illustrated by two child folders: Inbox 210 and Sent Messages 230, which are arranged on a first sublevel 291. In addition, a number of messages, illustrated as Emailₙ 211 may be arranged on this first sublevel 291. The Inbox node 210 in turn has a number of child nodes, which are message nodes illustrated in FIG. 2 with Email₁ 220 and Email₂ 225 arranged on a second sublevel 292. Further, each message, e.g. Email₁ and Email₂ has a number of child nodes, which are attachments that were attached to the message when it was originally received. The attachments are arranged on a third sublevel 293 and are illustrated in the figure by Attachment_{A} 221, Attachment_{B} 222, which are both children to Email₁ 220, and Attachment_{C} 226, child to Email₂.

As illustrated in FIG. 2, in the node hierarchy all email attachments have reference to its parent email node, that in turn have reference to its email folder that in turn have reference to its email account. Each email account 200, 250, each email folder 210, 230, each email message 211, 220, 225, and each email attachments 221, 222, 226 are stored as separate nodes in the email storage 21. The nodes are all unique and are identified with a unique identification mark. I.e. each email account, each email folder, each email message and each email attachment is allocated a unique identification mark.

A similar hierarchy is created for the document storage 22. I.e. the documents stored in the document storage 22 have reference to their parent folders, which parent folders in turn have reference to their document archives.

According to the invention, these hierarchies and nodes are shared between the email database and the mobile terminal and is the base for communication between the mobile terminal and the email database. To each node additional information can be associated, e.g. properties/meta data (e.g. document names, dates, keywords etc.), processed information (e.g. document data, PDF, visual representations (see below for more information) and text), hyperlinks and other information that may be related to each node. Communication between the user interface 12 of the mobile terminal 10 and the email database 20 is based on the nodes with their identification marks. This allows the user interface to represent nodes hierarchically (as well as in other formats) and make the hierarchy browsable, that is, possible to navigate. On demand the user interface can fetch other node related information such as visual representations (see below for more information).

A purpose of the invention is to make it fast and easy to compose email messages with attachments. By using the identification marks and the node hierarchy, for a user to send an email message with attachment, the user interface part only has to send the text of the message, as well as information (i.e. identification mark) of which attachments to attach to the message to the email database. Thereafter, the email database uses the attachment information to fetch the actual attachment from the email storage and add the attachment to the email message, which is sent via the outgoing email server 70 to the recipients.

Basically, when a user is about to compose and send a new email message with attachment, the following process is performed, according to an embodiment of the invention. In the user interface the user chooses to add an attachment. A view with all saved email messages (of e.g. the inbox) or at least all saved email messages that has attachments will then be shown on the display. When the User via an input device, e.g. a touch screen, selects one of the viewed email messages, the attachments of the email message will be shown. Thereafter, when the user via the input device selects one of the attachments, the selected attachment is added to the email message being composed. However, the selected attachment is not downloaded to the mobile terminal, only information, such as an identification mark, of the selected attachment is downloaded to the mobile terminal. Thereby, remote attachment management is achieved. Also, the user can cherry-pick whichever attachment the user wants out of an already existing email message, e.g. an email message residing in the inbox or in the sent items folder, and add the attachment to the email message being composed.

The folder structure of the email account can also be navigated to select attachments of an email message that has been saved in any folder, e.g. inbox, sent items etc. Furthermore, it is possible to navigate to a top level where all the user's email accounts, as well as remote document archives are shown.

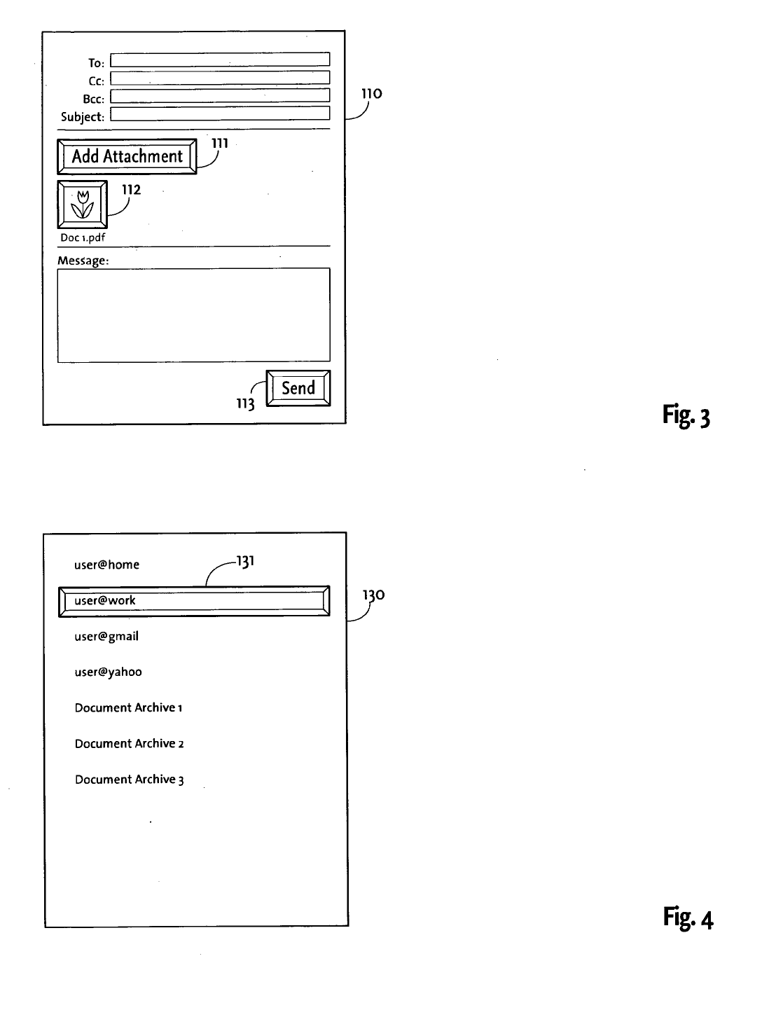

Below a method for composing and sending a new email message with attachment is described in more detail with reference to FIGS. 3-8. FIGS. 3-7 describe the different views that are displayed on the display of the mobile terminal when attaching an attachment to an email message to be composed, for an example of a folder content, whereas FIG. 8 describes the hierarchical node tree for this example. When a user is about to compose a new email message, a “compose email”-view 110, see FIG. 3, is shown on the display of the mobile terminal. The “compose email”-view 110 is reached through a user input command via an input device of the user interface 12. In the example of a “compose email”-view shown in FIG. 3, an attachment 112, shown as a thumbnail, is already attached to the new email message. Via the input device(s) the user provides other data, such as recipients, subject, message text, signature, mark-up etc. Also, by e.g. clicking on the box “Add attachment” 111 the user may select to attach one or several attachments.

When the user input command to attach a document has been received by the mobile terminal, the “choose email account and documents archive”-view 130 is displayed (FIG. 4). The view 130 shows the email accounts and the document archives that belong to the user. Information necessary for displaying the view 130 is received from the email database, based on the node hierarchy. In general, the mobile terminal 10 fetches enough information from the email database 20 to create each of the different user interface views displayed in FIGS. 3-7. According to one embodiment, the whole node hierarchy with all identification marks may be downloaded from the email database to the mobile terminal and stored e.g. in a memory 14 of the mobile terminal. Alternatively, only necessary information for the coming hierarchical level with possible selections is downloaded at each hierarchical level. I.e. in the case of FIG. 4, only the identification marks of the displayed email accounts and document archives are downloaded, i.e. the top level of FIG. 8.

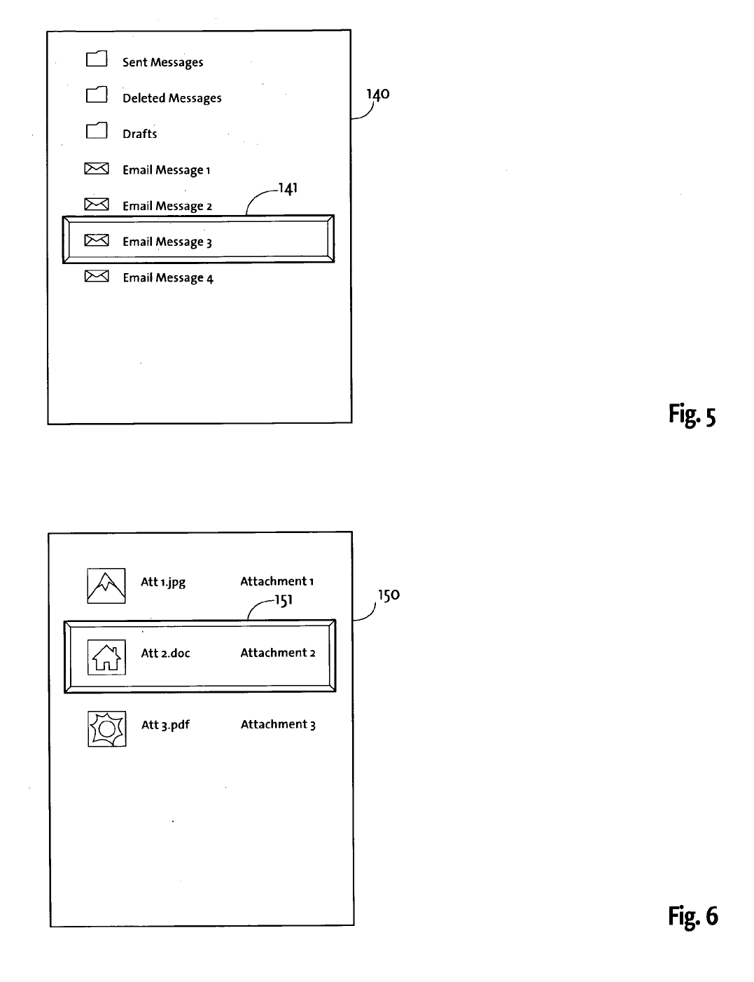

In the example of FIG. 4, the user selects the email account user@work 131 by a user input command, e.g. by clicking on a touch screen. The mobile terminal 10 then fetches information, i.e. identification marks regarding folders and email messages that are stored in this email account, based on the node hierarchy. If the whole node hierarchy has been downloaded, the processor 11 of the mobile terminal fetches the information from the internal memory 14. Otherwise, the processor 11 fetches this information from the email database 20. A “Select email”-view (FIG. 5) is then shown on the display. Alternatively, if the user selects a document archive, e.g. Document archive 1, the mobile fetches information from the email database regarding documents stored in Document archive 1, based on the identification marks and the node hierarchy.

The “Select email”-view 140 shown in FIG. 5 displays all email messages (Email message 1, Email message 2, Email message 3, Email message 4), as well as subfolders (Sent Messages, Deleted Messages, Drafts) of the user@work account 131. In the example of FIG. 5, the user selects Email message 3, 141, e.g. by clicking on a touch screen of the user interface 12. The mobile terminal then fetches information, either from the email database 20 or from the internal memory 14 if already downloaded, regarding attachments belonging to Email message 3, based on the identification marks and the node hierarchy. An “Add attachment from saved email”-view 150 (FIG. 6) is then shown on the display. Alternatively, if the user selects a sub folder, e.g. Sent Messages, the email messages stored in the folder Sent Messages folder will be displayed in a similar way as the email messages shown in FIG. 5.

The “Add attachment from saved email”-view 150 shown in FIG. 6 displays all attachments, Attachment 1, Attachment 2, Attachment 3, that belong to Email message 3. In the example of FIG. 6, the user selects Attachment 2, 151, e.g. by clicking on a touch screen of the user interface 12. The Attachment 2 is then added to the email message that is in composition. More correctly, identification information necessary for finding Attachment 2 in the email database 20 is added to the email message that is in composition. The identification information is found via the node hierarchy. After the Attachment 2 has been added, the “Compose email”-view is shown again. Alternatively, it may be possible to stay in Add attachment from saved email”-view and attach another attachment to the email message directly. It may also be possible for the user to select multiple documents directly in the “Add attachment from saved email”-view.

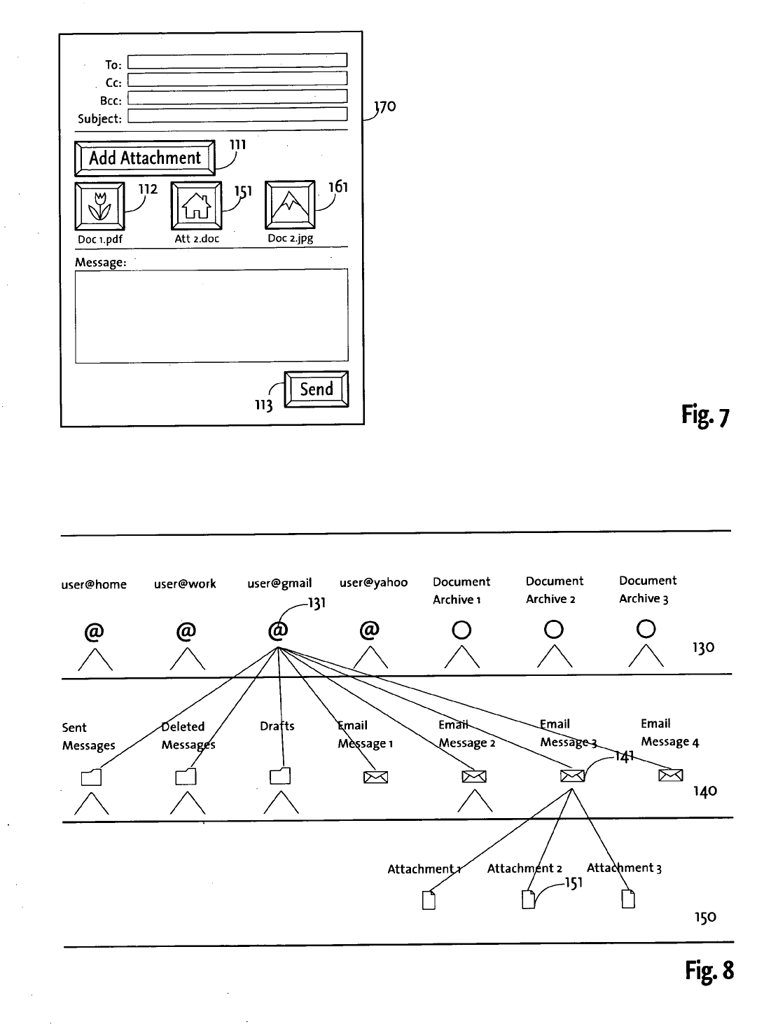

When the “Compose-email”-view has been displayed again, the user can select to add a new attachment to the email message to be sent, as well as both read and view the attachment before sending the email message to make sure the right document is actually attached, if such processing has been successful. The user can also delete any attachment that has been added. Any number of attachments can be added following the steps outlined above. FIG. 7 shows a “Compose email”-view 170 displaying a composed email message that is ready to be sent with attachments 112, 151, 161 added to it. When the user uses the input command “Send” 113 to send the message, the mobile terminal 10 sends a message as a composed email message to the Email database 20 over the air interface 30. The message comprises recipients and attachment identification marks, and preferably subject and message text. The attachment identification marks are used for fetching attachments from the email storage 21 and documents from the document storage 22. The fetched documents and attachments are then attached to the composed email message in the email database. Using this information, the server part 23 of the Email database 20 creates a MIME encoded email message, which is sent to the recipients through an email sending protocol via the communication link 60 and the external outgoing server 70.

As shown in FIGS. 3-7, the attachments could be cherry-picked from an old email message and added to an outgoing new email message. Thereby, the attachments can be added on the fly. As the attachments are stored in an email database remote from the mobile terminal, remote attachment management is achieved such that bandwidth resources over the air interface between the email database and the mobile terminal is saved.

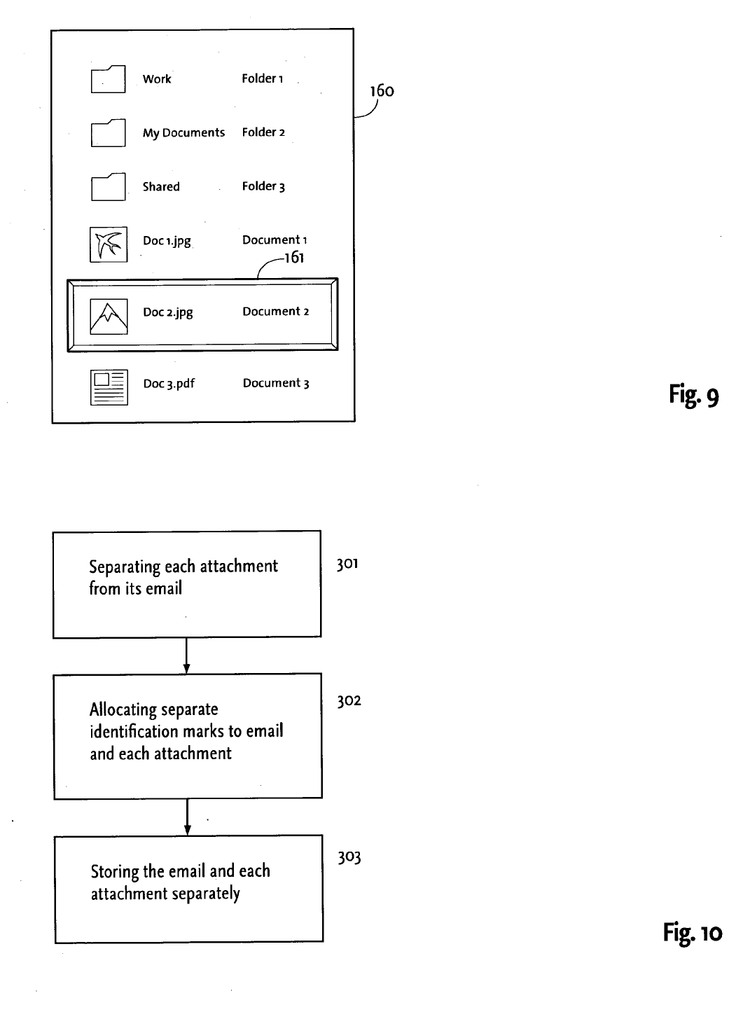

As indicated above, also documents from the document archive could be added as attachments to an outgoing email message. An “Add Document from Document Archive as Attachment”-view 160 is shown in FIG. 9. If the user selects a document, e.g. Document 2 161, the document will be attached to the email message that is in composition. Thereafter, the “Compose email”-view 110 may be displayed again.

According to an embodiment, the user may only have one user account. In that case, the top levels of FIG. 2 and FIG. 8 may not be necessary to display as the view of FIG. 4 when a user input command to add an attachment to an email message is received by the mobile terminal. In that case a “Select email”-view similar to the view of FIG. 5 will be displayed directly when the user selects the “Add Attachment”-box.

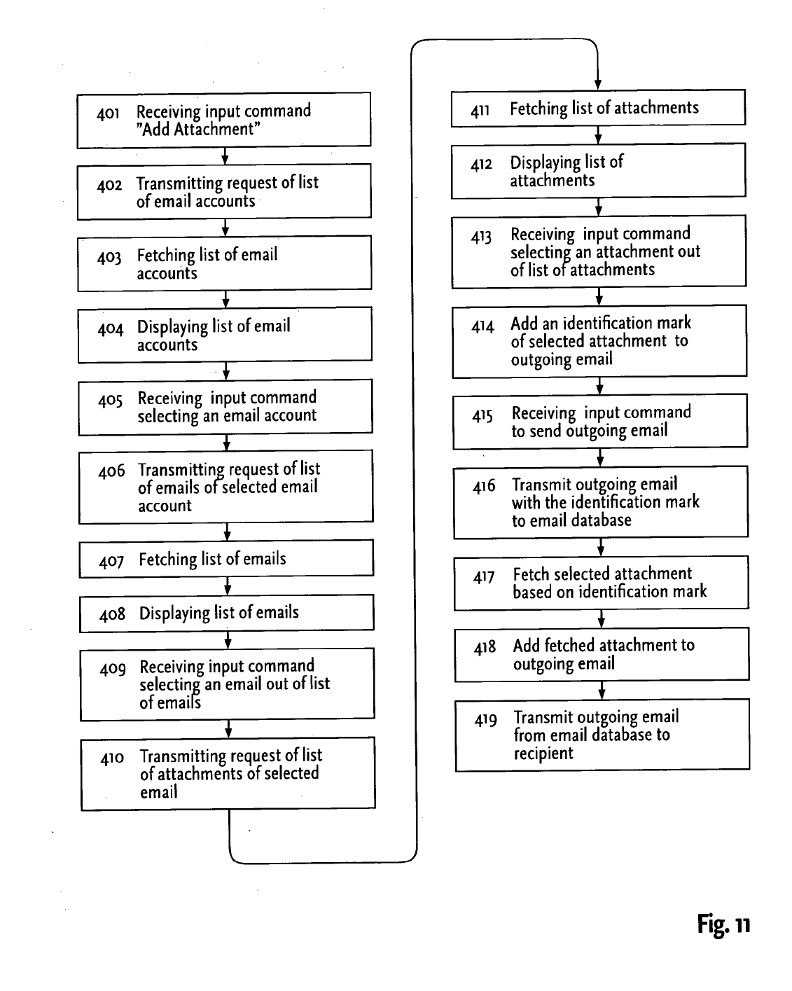

FIG. 10 describes an embodiment of a method for storing a processed email message in the email database. By a processed email message is meant e.g. an email message that has been received to the email handling system 5 from an incoming email server 50 or that has been sent from the email handling system 5 to the outgoing email server 70. When an email message with attachments attached to it is about to be stored, the email database 20 separates 301 each attachment from the email message, allocates 302 separate identification marks to the email message and to each attachment, and stores 303 the email message and each attachment separately in the email database. Preferably, the server part 23 performs each of the steps and stores the email message and each attachment in the email storage 21. The email message and its attachments are allocated identification marks to create a node hierarchy such that each attachment has a reference to its email message, even if they are stored separately.

FIG. 11 describes an embodiment of a method for attaching attachments of old email messages to outgoing email messages according to the invention.

The method starts with the mobile terminal 10 receiving 401 an input command from a user via the user interface of the terminal to add an attachment to an email message that is to be sent. The input command triggers the terminal 10, or actually the processor of the terminal in connection with the transceiver, to transmit 402 a request to the email database 20, requesting a list of email accounts belonging to a user. The request triggers the email database to fetch 403 the list of email accounts in its email storage and to transmit the list of email accounts to the mobile terminal. The list of email accounts comprises at least identification marks of each email account. The list of email accounts is then displayed 404 in the user interface. The above mentioned steps are optional, and may be skipped, e.g. if the user only has one user account. In this case step 406 will be triggered by the mobile terminal 10 receiving 401 an input command from a user via the user interface of the terminal to add an attachment to an email message that is to be sent.

Following step 404, step 406, that the mobile terminal transmits a request to the email database, requesting a list of email messages and/or folders belonging to a selected email account, is triggered by the mobile terminal receiving 405 an input command from a user via the user interface of the terminal that the user has selected an email account out of a number of user accounts. The transmitted request 406 triggers the email database to fetch 407 the list of email messages and/or folders and to transmit the list of email messages and/or folders to the mobile terminal. The list of email messages and/or folders comprises at least identification marks of each email message and/or folder. The list of email messages and/or folders is then displayed 408 in the user interface. In case the user then selects a folder, a new list of email messages belonging to the selected folder will be displayed in the same way as described above.

If the user instead selects an email message out of the list of email messages and/or folders, an input command is received 409 in the mobile terminal for selecting an email message out of the list of email messages. This received input command triggers the mobile terminal to transmit 410 a request to the email database, requesting a list of attachments belonging to the selected email message. The transmitted request 410 triggers the email database to fetch 411 the list of attachments belonging to the selected email message and to transmit the list of attachments to the mobile terminal. The list of attachments comprises at least identification marks of each attachment. The list of attachments is then displayed 412 in the user interface.

The mobile terminal then receives 413 an input command from the user via the user interface that the user has selected to attach one of the displayed attachments of the list of attachments. This received input command triggers the mobile terminal to add 414 an identification mark of the selected attachment to the email message to be sent. If the mobile terminal then receives 415 an input command to send the email message, the mobile terminal transmits 416 the email message with the identification mark of the selected attachment to the email database, the email database fetches 417 the selected attachment from its email storage based on the identification mark added to the outgoing email message and adds 418 the fetched attachment to the email message. The email message with the added attachment is then transmitted 419 from the email database to a recipient via an outgoing external email server and a communication system.

If the user wants to add more than one attachment to the email message to be sent, the user may trigger an add attachment command again, which is received by the mobile terminal. The mobile terminal may then either display the list of attachments belonging to the previously selected email message, the list of email messages and/or folders or the list of user accounts, depending on e.g. user settings.

In the method described above, the mobile terminal at each user input command requests and receives information from the email database. According to another embodiment the email database at the first request sends the whole node hierarchy, i.e. identification marks of all user accounts, all folders, all email message and all attachments. In that case, at following user input commands it will not be necessary for the mobile terminal to request any information from the email database. It may also be possible that a mixture of both methods is used. E.g. the email database may send identification marks of all email messages in a folder and all attachments belonging to these email messages, but at a first request only sending the identification marks of the different user accounts.

According to another embodiment, it is possible to attach only an email message, without its attachments. In that case, a user input command to add an email message is used. The mobile terminal fetches the email message via the email database and displays the nodes of the node hierarchy in a similar way as described above, but instead of attaching an attachment of the email message, the actual email message is attached. This is possible since the email messages and attachments are stored separately with separate identities. Also, by storing email messages and attachment separately with separate identities as described, it may be possible to add attachments from different stored email messages by navigating through the email hierarchy.

According to an embodiment, the invention also comprises a mobile terminal 10 for use in an email handling system as described in this disclosure. The mobile terminal has a processor 11 and a user interface 12 for displaying information to the user and for receiving user input commands. The processor 11 is arranged for fetching from the email database 20 and displaying on the user interface 12, a list of email messages of an email account, responsive to an input command from a user to add an attachment to an outgoing email message. The processor 11 is further arranged for fetching from the email database 20 and displaying on the user interface 12, a list of attachments of a selected first email message out of the list of email messages, responsive to an input command from a user selecting the first email message. The terminal is further arranged for adding to the outgoing email message, at least an identification mark of a selected first attachment out of the list of attachments, responsive to an input command from a user selecting the first attachment.

According to an embodiment of the invention it is possible to display a visual representation of an attachment that has been added to an email message in composition, such as the attachments 112, 151, 161 in FIG. 7. The visual representation may be a part of the attachment, e.g. a first page in a compressed format, with enough information to visually identify the document attached. It may be of interest to display a visual representation of an attached document before sending it to identify and verify visually that this is the document that the user in fact intended to send as an email attachment.

To display a visual representation of an attachment, the user selects one of the added attachments from the “Compose-email”-view, by e.g. clicking on the attachment. The mobile terminal then downloads, from the email database, the visual representation based on the identification mark of the attachment. According to embodiments, also the document name, the document type, the total number of pages and/or a thumbnail for each page is downloaded. It may also be possible for a user to select and zoom in on each page. If one page is selected by the user, a preview image of the page is downloaded, and if the user uses a zoom command for zooming in on the page, tile images necessary to display the next zoom level is downloaded from the email database.

For making it possible to download and display such a visual representation, the email database is arranged to cut up the attachment into parts, depending on the request of the user. This is achieved by providing the email database with common document programs, such as office suites and image processing programs. The email database is then arranged to run the right document program for executing the document, and from this program pick the part of the document requested by the user and send it to the mobile terminal.

Below is an embodiment of a method for viewing a document attached to an email message described. An input command from a user to view a part of an attached document triggers the mobile terminal to request a visual representation of the part of the attached document, from the email database. Such a request triggers the email database to produce a visual representation of the part of the attached document. The email database then transmits the produced visual representation to the mobile terminal, which displays the visual representation in its user interface.

According to another aspect of the invention, the invention may be accomplished by a computer program arranged to perform the steps according to any of the described methods of the invention. The computer program may be arranged on a computer-readable medium to be loadable into a processor of the email handling system according to the invention. The computer program product is then preferably arranged in the processor of the mobile terminal and in the email database, distributed between the two nodes of the communication system.

According to an alternative embodiment of the invention, the email database may be arranged in the mobile terminal instead of in a communication network node. In this case, the processor of the mobile terminal will request information from the email database arranged in the mobile terminal, similar to as described in the method above.

As understood by a person skilled in the art, the invention may be applicable not only for composing a new email message, but for replying to a received email message or for forwarding a received email message.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A method for handling email messages in a mobile communication system comprising a mobile terminal and an email database, the method comprising:
displaying, in a user interface of the mobile terminal, a list of email messages of an email account, responsive to an input command from a user to add an attachment to an outgoing email message;
displaying, in the user interface of the mobile terminal, a list of attachments of a selected first email message out of the list of email messages, responsive to an input command from a user selecting the first email message;
adding to the outgoing email message, a selected first attachment out of the list of attachments, responsive to an input command from a user selecting the first attachment.

2. Method according to claim 1, further comprising the steps of:
storing each processed email message and each attachment attached to each processed email message separately, such that an attachment is stored separated from the email message with which it was attached, and
allocating separate identification marks to each processed email message and to each attachment attached to each processed email message,
wherein the step of displaying a list of email messages comprises displaying the list of email messages based on the identification marks of each email message, wherein the step of displaying attachments of a selected email message comprises displaying the attachments based on the identification mark of the email message and the identification mark of each attachment of the selected email message,
and wherein the step of adding the selected attachment comprises adding the selected attachment based on its identification mark.

3. Method according to claim 2, wherein the processed email messages and attachments of the processed email messages are stored in a node hierarchy based on the identification marks, such that each attachment has a reference to its processed email message.

4. Method according to claim 2, wherein the documents and email messages are stored on the email database, wherein the email database and the mobile terminal are connected via an air interface connection, and wherein the steps of displaying a list of email messages and displaying a list of attachments to a selected email message in a user interface of the mobile terminal further comprises transmitting to the mobile terminal from the email database the identification marks of the processed email messages and of the attachments, in response to an input command from a user.

5. Method according to claim 1, wherein the step of adding to the outgoing email message a selected attachment out of the list of attachments comprises:
adding, in the mobile terminal, an identification mark of the selected attachment to the outgoing email message,
transmitting the outgoing email message with the identification mark of the selected attachment to the email database,
fetching, in the email database, the selected attachment based on the identification mark added to the outgoing email message,
adding the fetched attachment to the outgoing email message.

6. Method according to claim 1, further comprising the steps of, responsive to an input command from a user to view at least a part of a selected attachment:
producing, in the email database, a visual representation of a part of the selected attachment,
displaying, in the user interface, the visual representation of the part of the selected attachment.

7. Method according to claim 1, further comprising the step of:
displaying, in the user interface of the mobile terminal, a list of a email accounts of the user, responsive to an input command from a user to add an attachment to an outgoing email message,
and wherein the step of displaying a list of received email messages comprises displaying a list of received email messages of a selected first email account out of the list of email accounts, responsive to an input command from a user, selecting the first email account.

8. A computer program product arranged for performing the steps of claim 1.

9. An email handling system, comprising:
a mobile terminal having a processor and a user interface for displaying information to the user and for receiving user input commands,
an email database for storing email messages and attachments,
wherein the processor is arranged for fetching from the email database and displaying on the user interface, a list of email messages of an email account, responsive to an input command from a user to add an attachment to an outgoing email message;
wherein the processor is further arranged for fetching from the email database and displaying on the user interface, a list of attachments of a selected first email message out of the list of email messages, responsive to an input command from a user selecting the first email message;
wherein the system is further arranged for adding to the outgoing email message, a selected first attachment out of the list of attachments, responsive to an input command from a user selecting the first attachment.

10. Email handling system according to claim 9, wherein the email database is arranged for storing each processed email message and each attachment of each processed email message separately, such that an attachment is stored separated from the email message with which it was attached, and wherein the email database is further arranged for allocating separate identification marks to each processed email message and to each attachment,
wherein the processor is arranged for fetching the identification marks of each email message of an email account from the email database and displaying the list of email messages on the user interface based on the identification marks of each email message, and
wherein the processor is arranged for fetching the identification mark of each attachment of the selected email message from the email database based on the identification mark of the email message and displaying the attachments of the selected email message on the user interface based on the identification mark of the selected email message and the identification mark of the attachments of the selected email message,
and wherein the email database is arranged for adding the selected attachment to the outgoing email message by fetching the selected attachment based on its identification mark.

11. Email handling system according to claim 10, wherein the email database is arranged for allocating identification marks to the processed email messages and to the attachments of each processed email message and storing the email messages and attachments, such that each attachment has a reference to its email message with which it was attached, and such that each email message has a reference to each attachment originally attached to the email message.

12. Email handling system according to claim 9, wherein the mobile terminal and the email database are arranged to communicate with each other via an air interface connection.

13. Email handling system according to claim 12, wherein the system is further arranged for adding to the outgoing email message, a selected first attachment out of the list of attachments by:
the mobile terminal being arranged for:
adding the identification mark of the selected attachment to the outgoing email message,
transmitting the outgoing email message with the identification mark of the selected attachment to the email database,
the email database being arranged for:
fetching the selected attachment based on the identification mark added to the outgoing email message,
adding the fetched attachment to the outgoing email message.

14. Email handling system according to claim 9, wherein the email database is arranged for, responsive to an input command from a user to view at least a part of a selected attachment, producing a visual representation of a part of the selected attachment, and
wherein the processor is arranged for, responsive to an input command from a user to view at least a part of a selected attachment, displaying, in the user interface, the visual representation of the part of the selected attachment.

15. A mobile communication terminal arranged for use in an email handling system according to claim 9.
